(19) United States
(12) Patent Application Publication
(10) Pub. No.: US 2006/0128435 A1
(43) Pub. Date: Jun. 15, 2006

(54) Antenna signal switching device and method for switching antenna signal

(75) Inventor: Chih-Yung Lu, Chupei City (TW)

Correspondence Address: TROXELL LAW OFFICE PLLC;SUITE 1404, 5205 LEESBURG PIKE, FALLS CHURCH, VA, 22041, US

(73) Assignee: AlfaPlus Semiconductor Inc.

(21) Appl. No.: 11/011,106

(22) Filed: Dec. 15, 2004

(51) Int. Cl. H04B 17/02

(52) U.S. Cl. 455/562.1

(57) ABSTRACT

An antenna signal switching device includes two antennas and a switching circuit is connected to the two antennas. The device includes an ANTSEL to switch the signals of one of the two antennas to the switching circuit. A signal receiving module receives signals coming from the switching circuit and sends the received signals out. A glitch detection module which detects if there is a glitch in the signal. The method for switching the antenna signals comprises a step of using a switching circuit to connect with two antennas and a signal received by one of the antennas and entering the switching circuit; a step of analyzing the signal if it is a glitch, and a step of that if the signal is a glitch, the other antenna is set to receive signals by the switching circuit.

### FIELD OF THE INVENTION

The present invention relates to an antenna signal switching device and a method for switching the antenna signals, particularly by using the techniques of detection of glitches so as to shorten the time required for judging attenuation of signals.

### BACKGROUND OF THE INVENTION

It is important to send signals from one place to another in the field of radio communication. As shown in FIG. 1, a signal emitting system 90 includes a transmitter 91, a channel 92 and receiver 93, wherein the transmitter 91 transfers the input signals into desired forms such as transferring analog signals into digital signals, or audio signals into electric voltage signals, and then sends the transferred signals to the channel 92. The input signals are modulated to change the amplitudes, phases and the frequencies of the signals. The transmitter 91 further filters, magnifies and couples the modulated signals to the channels. The channels are the communication paths between the transmitter 91 and the receiver 93, such as radio stations send signals from transmitting antennas to the channel of radios. The receiver 93 demodulates the signals.

The signals are degraded via channels 92 because of affections from different types of noise, other signals, interruption or signals fading. Therefore two sources of noise, one of which comes from internal parts such as noise coming from resistances and electronic tubes, and the exterior noise such as atmosphere noise, artificial signals and signals from outer space. Multi-path transmission is one of the sources of noise. Signals are reflected by buildings, airplanes, ships and metal objects and the signals fade. This can be improved by way of antenna diversity.

The antenna diversity uses a switch device which is connected to two antennas at different locations and the collected and demodulated signals are sent to a device to judge which antenna is the suitable one to receive the signals. By this way, the signals are maintained to have higher quality. As shown in FIG. 2, a method for detecting signals fading depends on the structure of IEEE WLAN 802.11b. A frame includes a PLCP Preamble, a PLCP Header and a PSDU comprising signals. The PLCP Preamble includes a synchronization field (SYNC) of 128 bits and SDF of 16 bits. The PLCP Header includes Signal fields of 16 bits, Service field, Length field and CRC field. It takes a lot of time to read the synchronization field or CRC field before judging the fading of the signals, and the frame is disappeared after the processes are finished. It is obvious that the response time is too long to be satisfied.

The present invention intends to provide a method for detecting glitches so as to detect the signals fading of antenna diversity, and to shorten the response time.

### SUMMARY OF THE INVENTION

The present invention relates to an antenna signal switching device that includes a switching circuit connected to two antennas. An ANTSEL (antenna selection) switches the signals of one of the two antennas to the switching circuit if a glitch is detected. A signal receiving module receives signals coming from the switching circuit and sends the received signals out. A glitch detection module which detects if there is a glitch in the signal.

A method for switching the antenna signals comprises a step of using a switching circuit to connect with two antennas and a signal received by one of the antennas and entering the switching circuit; a step of analyzing the signal if it is a glitch, and a step of that if the signal is a glitch, the other antenna is set to receive signals by the switching circuit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 illustrates a conventional signal emitting system;

FIG. 2 shows the signal frame of WLAN 802.11b;

FIG. 3 illustrates the antenna signal switching device of the present invention;

FIG. 4 shows the glitch detection module of the present invention;

FIG. 5A is a waveform of a processed signal;

FIG. 5B is a waveform of a glitch signal;

FIG. 5C shows the inversion of the ANTSEL when the glitch is detected;

FIG. 6A shows the signal received by the first antenna;

FIG. 6B shows the signal received by the second antenna;

FIG. 6C shows the waveform of the data being transferred, and

FIG. 7 shows the method for switching antenna signal of the present invention.

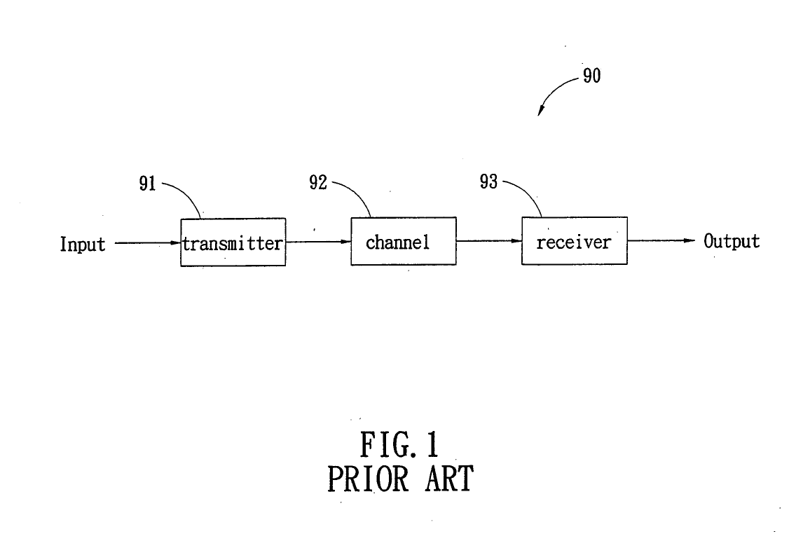

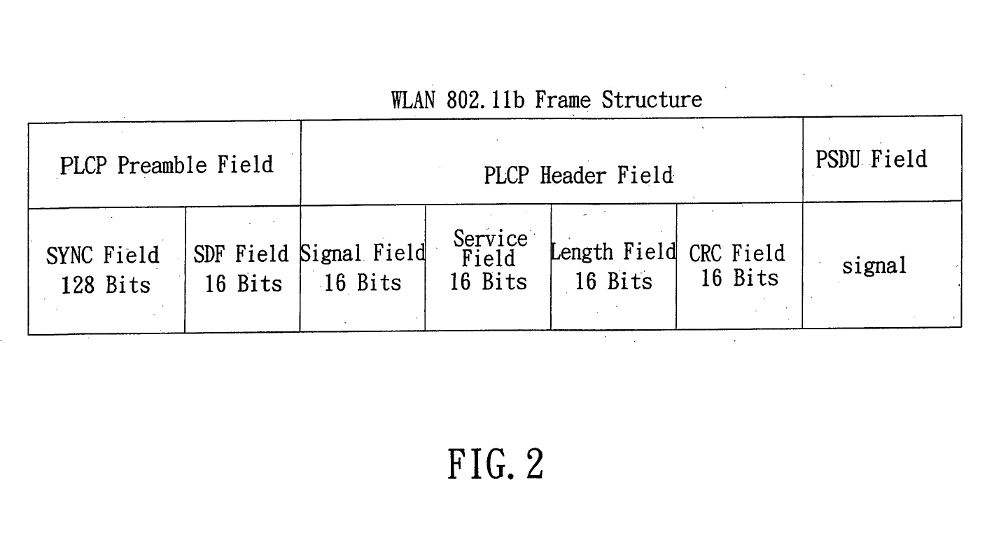

### DETAILED DESCRIPTION OF THE PREFERRED EMBODIMENT

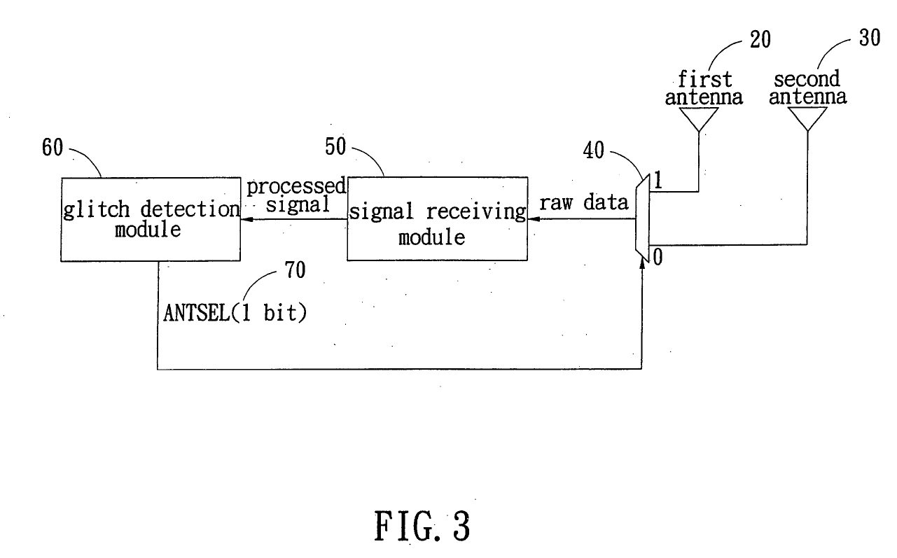

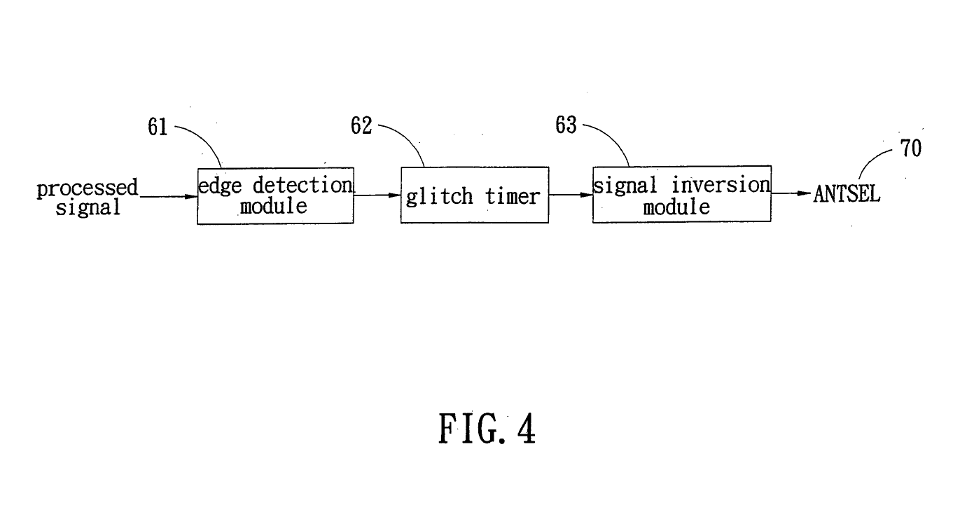

Referring to FIGS. 3 to 6, the antenna signal switching device 10 of the present invention comprises a first antenna 20 and a second antenna 30, a switching circuit 40 connected to the first and second antennas 20, 30 and including an ANTSEL 70 of 1 bit to switch the signals of one of the two antennas 20, 30 to the switching circuit 40. In this embodiment, when the ANTSEL 70 is “1”, the signals are input from the first antenna 20, and when the ANTSEL 70 is “0”, the signals are input from the second antenna 30. When one of the two antennas 20, 30 receives a raw data, especially a radio frequency (RF), the signal is sent to a signal receiving module 50 via the switching circuit 40 and the signal is demodulated by the signal receiving module 50 and sent to a glitch detection module 60 which detects if there is a glitch in the signal. If the glitch is detected, the ANTSEL 70 inverses and sends the signal to the switching circuit 40 and so that the other antenna being designated to receive signals. This is to say, the signal is input from the first antenna 20 when the ANTSEL is “1”, the inversed signal changes ANTSEL 70 to be “0” and is input from the second antenna 30. Because the ANTSEL 70 can be changed quickly, the response time is shortened.

The glitch detection module 60 includes an edge detection module 61 so as to detect edges of signals, a glitch timer 62 and a signal inversion module 63. The processed signals include rising edges and falling edges. The edge detection module 61 is activated and reset when the edges are detected. The glitch timer 62 counts a duration from an edge of each signal till the period used by the glitch timer 62 is longer than a half of the duration. When the duration that is detected by the glitch timer 62 is less than a ratio of the duration of the signal, the signal is judged to be a glitch. The signal inversion module 63 sets the ANTSEL 70 to be inversed and sends to the switching circuit 40 to change the other path of input of the signals. In this embodiment, the glitch is defined by the duration of detected signal being less than ½ of the duration of signals.

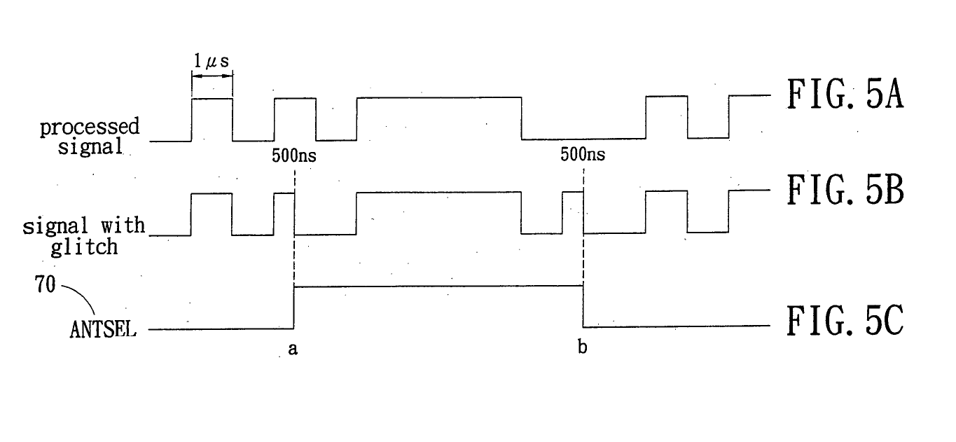

Referring to FIGS. 5A to 5C, a processed signal has a waveform as shown in FIG. 5A and the duration is 1 μs when the speed of the signal is 1 Mbps, this duration is calculated by the glitch timer 62 which starts to calculate on the rising edge or the falling edge and ends at the falling edge or rising edge, and the glitch timer 62 calculates the next duration after each term of calculation. That is to say, when the glitch timer 62 calculates the signal at the point “a” in FIGS. 5B and 5C and the detected signal has a duration less than 500 ns, it is recognized as a glitch. The signal inversion module 63 inversely sends the signal to switching circuit 40 and the other antenna is set to receive the signal. When the glitch timer 62 calculates the signal at the point “b” in FIGS. 5B and 5C and the detected signal has a duration within 500 ns, it is recognized as a glitch again. The signal inversion module 63 inversely sends the signal to switching circuit 40 and the other antenna is set to receive the signal. Following the rules, when the rate of the speed of the signal is 2 Mbps and the duration is 500 ns, if the detected signal has a duration less than 250 ns, it is a glitch.

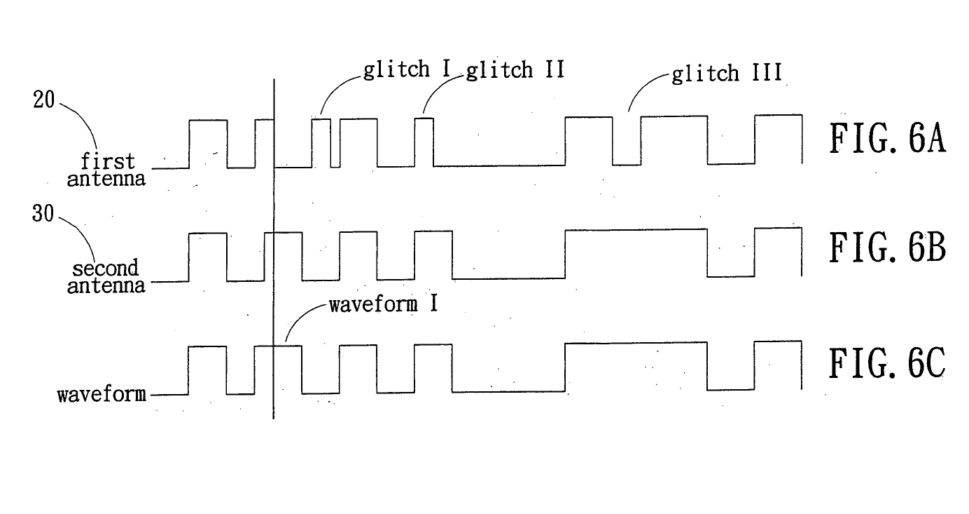

As shown in FIGS. 6A to 6C, when a data is sent and the first antenna 20 receives the signal, when the signal is received to the waveform “I”, the detected signal has a duration less than a half of the duration of the data, the signal is a glitch. The ANTSEL 70 with 1 bit switches the receiving end to the second antenna 20 so as to completely receive the whole signal without loss. Even if the signal received by the first antenna 20 includes glitches I, II, III, the complete data is received.

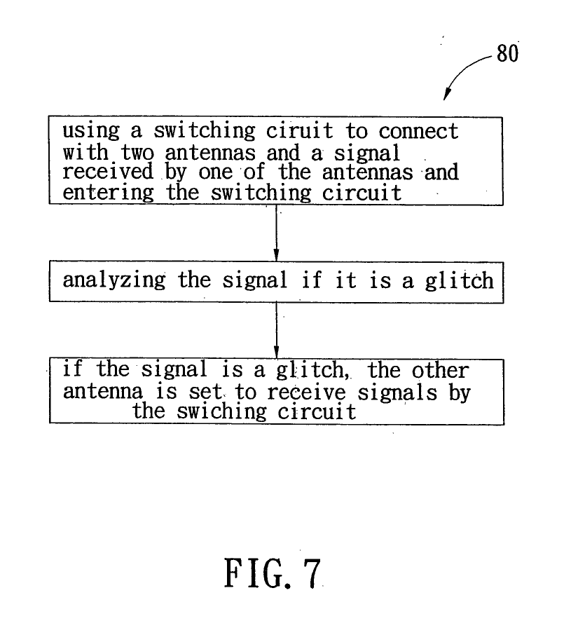

As shown in FIG. 7, the method 80 for switching the antenna signals includes the following steps:

step a: using a switching circuit 40 to connect with two antennas and a signal received by one of the antennas and the signal entering the switching circuit 40;

step b: analyzing the signal if it is a glitch, and

step c: if the signal is a glitch, the other antenna is set to receive signals by the switching circuit 40.

The timer 62 is reset when any signal is detected with edges and the timer can be any mechanism that has the ability of counting. When the duration of a detected signal is less than a pre-set ratio of the signal duration, it is recognized as a glitch, in this embodiment, the ratio is ½.

The switching circuit 40 is activated by using an ANTSEL 70 and one of the antenna receives a signal which is sent to the switching circuit. When a glitch is detected, the ANTSEL 70 inversely sends the signal to the signal switching circuit 40 so as to activate the other antenna to receive signals. The signals are input from the first antenna when the ANTSEL 70 is 1 bit, and the signals are input from the first antenna 20, and when the ANTSEL 70 is “0”. By doing so, the response time for the signal fading is shortened and the quality of the signals is increased.

The device of the present invention minimizes the problems of the multi-path and the response time for the signal fading is shortened. The response time is tremendously reduced because the method of the present invention only calculates ½ of the duration to check if there is a glitch. The device includes simple structure and involves low manufacturing cost.

While we have shown and described the embodiment in accordance with the present invention, it should be clear to those skilled in the art that further embodiments may be made without departing from the scope of the present invention.

What is claimed is:

1. An antenna signal switching device comprising:
a first antenna for receiving signals;
a second antenna for receiving signals;
a switching circuit connected to the first and second antennas and including an ANTSEL to switch the signals of one of the two antennas to the switching circuit;
a signal receiving module which receives signals coming from the switching circuit and sending the received signals out, and
a glitch detection module for detecting if there is a glitch in the signal, if the glitch being detected, the ANTSEL being inversed and sent to the switching circuit and so that the other antenna being designated to receive signals.

2. The device as claimed in claim 1, wherein the glitch detection module includes an edge detection module so as to detect edges of signals, a glitch timer and a signal inversion module, the glitch timer being activated and reset when the edges are detected, a signal inversion module inversing the ANTSEL and sending to the switching circuit.

3. The device as claimed in claim 2, when a duration of a signal detected by the glitch timer is less than a ratio of duration of signals, the signal detected is recognized as a glitch and the ANTSEL is inversed.

4. The device as claimed in claim 3, when the duration of the signal detected by the glitch timer is less than ½ of the duration of signals, the signal detected is recognized as a glitch.

5. The device as claimed in claim 1, wherein the ANTSEL is 1 bit, the signal is received by the first antenna when the ANTSEL is “1”, and the signal is received by the second antenna when the ANTSEL is “0”.

6. The method for switching the antenna signals comprising the following steps:
step a: using a switching circuit to connect with two antennas and a signal received by one of the antennas and entering the switching circuit;
step b: analyzing the signal if it is a glitch, and
step c: if the signal is a glitch, the other antenna is set to receive signals by the switching circuit.

7. The method as claimed in claim 6, wherein the timer is reset when a signal is detected with edges and when a duration of a detected signal is less than a ratio of the signal duration, it is recognized as a glitch.

8. The device as claimed in claim 7, when the duration of the signal detected by the glitch timer is less than ½ of the duration of signals, the signal detected is recognized as a glitch.

9. The device as claimed in claim 6, wherein the switching circuit switches the signals of one of the two antennas to the switching circuit by the ANTSEL, when a glitch is detected, the ANTSEL is inversed and sent to the switching circuit and the other antenna is activated to receive signals.

10. The device as claimed in claim 9, wherein the ANTSEL is 1 bit, the signal is received by the first antenna when the ANTSEL is “1”, and the signal is received by the second antenna when the ANTSEL is “0”.
